(19) United States
(12) Patent Application Publication
(10) Pub. No.: US 2008/0154429 A1
(43) Pub. Date: Jun. 26, 2008

(54) Apparatus, method, and medium for distinguishing the movement state of mobile robot

(75) Inventors: Hyoung-ki LEE, Seongnam-si (KR); Joon-kee CHO, Yongin-si (KR); Seok-won BANG, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/976,208

(22) Filed: Oct. 22, 2007

(30) Foreign Application Priority Data
Dec. 21, 2006 (KR) 10-2006-0131855

(51) Int. Cl. G06F 19/00

(52) U.S. Cl. 700/258; 901/1

(57) ABSTRACT

An apparatus, method, and medium for distinguishing the movement state of a mobile robot are provided. The apparatus includes at least one driving wheel rotatably driven by a driving motor, a first rotation sensor to sense rotation of the driving wheel, at least one caster wheel installed corresponding to the driving wheel and freely moving with respect to a bottom surface, a second rotation sensor to sense rotation of the caster wheel, an acceleration sensor to measure acceleration of the mobile robot, an angular velocity sensor to measure angular velocity of the mobile robot, and a movement-state-distinguishing unit to distinguish movement states of the mobile robot through comparison of the velocity or acceleration of the driving wheel obtained by the first rotation sensor, the velocity or acceleration of the caster wheel obtained by the second rotation sensor, the acceleration obtained by the acceleration sensor, and the angular velocity obtained by the angular velocity sensor.

### CROSS-REFERENCE TO RELATED APPLICATIONS

This application claims priority benefit from Korean Patent Application No. 10-2006-0131855 filed on Dec. 21, 2006 in the Korean Intellectual Property Office, the disclosure of which is incorporated herein by reference in its entirety.

### BACKGROUND

1. Field

Exemplary embodiments relate to an apparatus, method, and medium for distinguishing the movement state of a mobile robot, and, more particularly, to an apparatus, method, and medium for-distinguishing the movement state, e.g., a slip state, of a mobile robot, using a rotation sensor of a driving wheel, a rotation sensor of a caster wheel, an accelerometer, and an angular velocity sensor, and accurately estimating a pose of the mobile robot according to the distinguished movement state of the mobile robot.

2. Description of the Related Art

Robots developed for industrial purposes as a part of factory automation, have recently been widely used in various ways. For example, robots are not only used as industrial robots or factory automation mobile robots but also as domestic robots, such as cleaning robots, guide robots and security robots, used in homes or offices.

In order to define a path for a mobile robot, e.g., a cleaning robot, it is necessary to build a map recognized by the mobile robot. A simultaneous localization and mapping (SLAM) algorithm using a Kalman filter or a Particle filter is one of the most widely used methods for building a map while a robot moves autonomously.

The most challenging issue in the SLAM algorithm is to accurately identify the position of a mobile robot using odometry because a position of an external feature point is registered by a sensor based on the position of the mobile robot, and then the position of the mobile robot is identified using the feature point.

Research into localization carried out using a gyro or an encoder is being conducted. Currently available techniques enable sensing only a slip state in a rotational direction of a robot. However, a slip state in a moving direction of the robot, which occurs most frequently, cannot be sensed. In addition to the slip state, the prior art technology is not suited to sense a skid state proposed in the present invention, nor to sense a treadmill state in which a bottom surface moves.

Accordingly, since the mobile robot is not driven in a normal state, accurate localization of the mobile robot cannot be achieved.

### SUMMARY OF THE INVENTION

In an aspect of embodiments, there is provided an apparatus, method, and medium for distinguishing the movement state, e.g., a slip state, of a mobile robot, using a rotation sensor of a driving wheel, a rotation sensor of a caster wheel, an accelerometer, and an angular velocity sensor, and accurately estimating a pose of the mobile robot according to the distinguished movement state of the mobile robot.

In an aspect of embodiments, there is provided a process for compensating for a bias of an accelerometer based on information regarding a rotation sensor of a caster wheel.

According to an aspect of embodiments, there is provided a apparatus for distinguishing the movement state of a mobile robot, the apparatus including a driving wheel rotatably driven by a driving motor, a first rotation sensor to sense rotation of the driving wheel and to determine velocity or acceleration of the driving wheel, a caster wheel installed corresponding to the driving wheel and freely moving with respect to a bottom surface, a second rotation sensor to sense rotation of the caster wheel and to determine velocity or acceleration of the caster wheel, an acceleration sensor to measure the acceleration of the mobile robot, an angular velocity sensor to measure the angular velocity of the mobile robot, and a movement-state-distinguishing unit to distinguish the movement state of the mobile robot through comparison of a velocity or acceleration of the driving wheel obtained by the first rotation sensor, a velocity or acceleration of the caster wheel obtained by the second rotation sensor, an acceleration obtained by the acceleration sensor, and an angular velocity obtained by the angular velocity sensor.

According to another aspect of embodiments, there is provided a method of distinguishing the movement state of a mobile robot, the method including: measuring a value of a first rotation sensor which senses rotation of a driving motor for rotating a first driving wheel while the mobile robot is moving and which determines velocity or acceleration of the driving wheel, a value of a second rotation sensor which senses rotation of a driving motor for rotating a caster wheel installed corresponding to the driving wheel and moving freely with respect to a bottom surface and which determines velocity or acceleration of the caster wheel, a value of an acceleration sensor which measures an acceleration of the mobile robot, and a value of an angular velocity sensor which measures an angular velocity of the mobile robot, and distinguishing the movement state of the mobile robot through comparison of a velocity or acceleration of the driving wheel, obtained by the first rotation sensor, a velocity or acceleration of the caster wheel, obtained by the second rotation sensor, an acceleration obtained by the acceleration sensor, and an angular velocity obtained by the angular velocity sensor.

According to another aspect of the present invention embodiments, there is provided an apparatus for estimating a pose of a mobile robot, the apparatus including a movement-state-distinguishing unit to distinguish movement states of the mobile robot through comparison of a measured velocity or measured acceleration of a driving wheel of a robot, a measured velocity or measured acceleration of a caster wheel installed corresponding to the driving wheel and freely moving with respect to the bottom surface, an acceleration of the mobile robot obtained by an acceleration sensor, and an angular velocity obtained by an angular velocity sensor; and a pose estimator to estimate a pose of the mobile robot according to the movement state of the mobile robot.

According to another aspect of embodiments, there is provided at least one computer readable medium storing computer readable instructions to implement methods of embodiments.

### BRIEF DESCRIPTION OF THE DRAWINGS

These and/or other aspects, features, and advantages will become apparent and more readily appreciated from the following description of exemplary embodiments, taken in conjunction with the accompanying drawings of which:

FIG. 1 is a block diagram of an apparatus for distinguishing the movement state of a mobile robot according to an exemplary embodiment;

FIG. 2 is a front view illustrating that a driving wheel and a caster wheel are installed according to an exemplary embodiment;

FIG. 3 is a perspective view of FIG. 2;

FIG. 4 is a diagram for explaining a rotation sensor, an acceleration sensor and an angular velocity sensor for a mobile robot according to an exemplary embodiment;

FIG. 5 is a diagram illustrating that a pose of a mobile robot is estimated according to an exemplary embodiment;

FIG. 6 illustrates a bias error of an accelerometer; and

FIG. 7 is a flowchart of a method for distinguishing the movement state of a mobile robot according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below by referring to the figures.

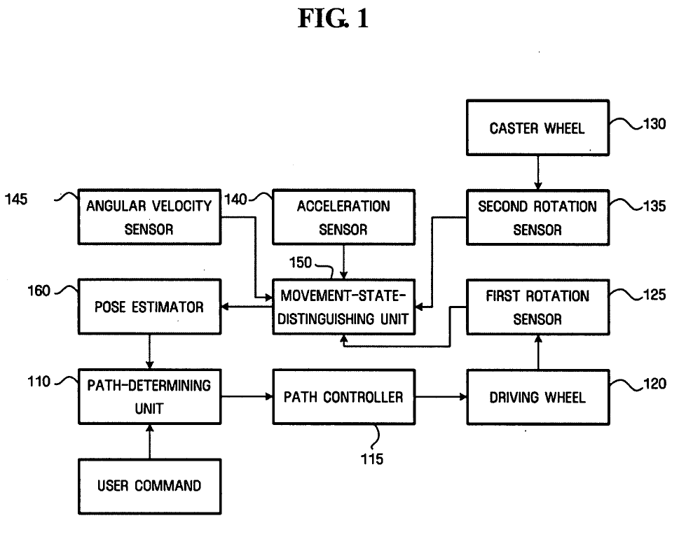

FIG. 1 is a block diagram of an apparatus for distinguishing the movement state of a mobile robot according to an exemplary embodiment.

The apparatus includes a path-determining unit 110, a path controller 115, a driving wheel 120, a first rotation sensor 125, a caster wheel 130, a second rotation sensor 135, an acceleration sensor 140, an angular velocity sensor 145, and a movement-state-distinguishing unit 150. The apparatus may further include a pose estimator 160.

The path-determining unit 110 makes a plan of a moving path of the mobile robot 100 according to a user command. While moving, the mobile robot 100 may renew its moving paths adaptively to the user command through a feedback for its current pose constantly provided from the pose estimator 160. Here, the pose of the mobile robot 100 is indicated by a position and an orientation of the mobile robot 100 on the X-y plane.

The path controller 115 controls a driving motor (not shown) that drives the driving wheel 120 of the mobile robot 100 to allow the mobile robot 100 to move as determined by the path-determining unit 110.

The driving wheel 120 are rotated by the driving motor (not shown), which drives the mobile robot 100. It is preferable to provide two driving wheels at left and right sides, respectively. However, three or four driving wheels may also be provided within the scope of exemplary embodiments. Since the first rotation sensor 125 is coupled to the driving wheel 120, the velocity and acceleration of the driving wheel 120 can be measured using the first rotation sensor 125.

The first rotation sensor 125 is coupled to the driving motor (not shown) to sense the rotation of the driving motor. Accordingly, the velocity and acceleration of the driving wheel 120 rotated by the driving motor can be identified by the first rotation sensor 125.

The first rotation sensor 125 is installed for each the driving wheel 120 in a one-to-one relationship. Preferably, the first rotation sensor 125 is an encoder.

The caster wheel 130 is physically separated from the driving wheel 120, and is installed to be independent of each other. In addition, the caster wheel 130 is installed to correspond to the driving wheel 120, and freely moves with respect to the bottom surface. That is to say, the caster wheel 130 moves only by a frictional force with respect to the bottom surface, unlike the driving wheel 120 rotating by the driving motor. The caster wheel 130 rotates only when it moves with respect to the bottom surface.

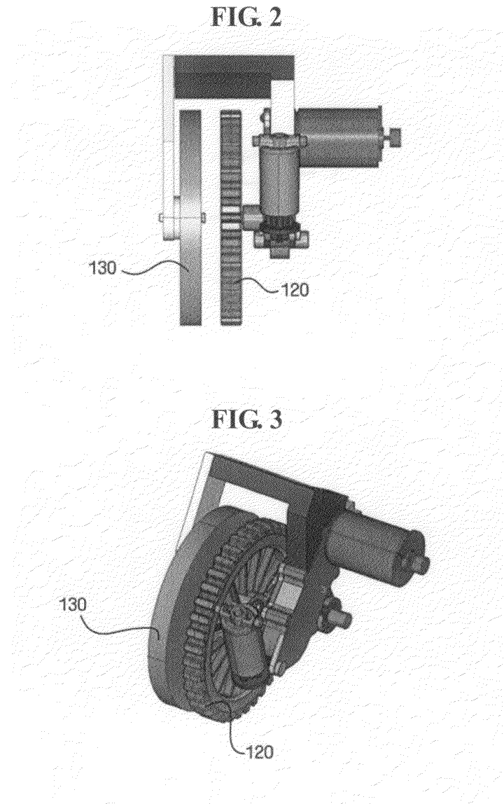

FIG. 2 is a front view illustrating that a driving wheel and a caster wheel are installed according to an exemplary embodiment, and FIG. 3 is a perspective view of FIG. 2. As shown in FIGS. 2 and 3, the caster wheel 130 is preferably formed at a side of the driving wheel 120 along the axis which is the same as the driving wheel 120. If the driving wheel 120 and the caster wheel 130 are far from each other, the caster wheel 130 may not rotate in a case where the mobile robot 100 is lifted. In such a case, the driving wheel 120 and the caster wheel 130 can be more accurately compared with each other in view of the velocity and acceleration by making the driving wheel 120 and the caster wheel 130 closer to each other. A detailed comparison-method pose is described below. In addition, the diameter of the caster wheel 130 is preferably the same as that of the driving wheel 120.

The second rotation sensor 135 is coupled to the caster wheel 130 to sense the rotation of the caster wheel 130. Accordingly, the velocity and acceleration of the caster wheel 130 can be identified using the second rotation sensor 135. The second rotation sensor 135 is formed to correspond to the caster wheel 130, like the first rotation sensor 125. Preferably, the second rotation sensor 135 may also be an encoder.

The acceleration sensor 140 is formed on the mobile robot 100 to measure (sense) the acceleration of the mobile robot 100. The acceleration sensor 140 is preferably formed at the driving center of the mobile robot 100. Examples of the acceleration sensor 140 include an accelerometer.

The angular velocity sensor 145 is formed on the mobile robot 100 to measure (sense) the angular velocity of the mobile robot 100. Like the acceleration sensor 140, the angular velocity sensor 145 is preferably formed at the driving center of the mobile robot 100. Examples of the angular velocity sensor 145 include a gyro.

The movement-state-distinguishing unit 150 determines the movement state of the mobile robot 100 using values measured by the first rotation sensor 125, the second rotation sensor 135, the acceleration sensor 140, and angular velocity sensor 145. Here, the movement state includes a normal state in which the mobile robot 100 normally moves with respect to the bottom surface, a slip state in which the driving wheel 120 idles with respect to the bottom surface, a skid state in which the driving wheel 120 skids with respect to the bottom surface, a treadmill state in which the bottom surface moves as the driving wheel 120 moves, an external-force-applied state, e.g., collision, in which an external force is applied to the mobile robot 100, or lift in which the mobile robot 100 is lifted by an external force, and so on. Methods of determining the respective states will later be described in detail.

The pose estimator 160 estimates the pose of the mobile robot 100 according to the movement state determined by the movement-state-distinguishing unit 150. Here, the pose of the mobile robot 100 refers to a position and an orientation of the mobile robot 100 on the x-y plane. A method of estimating the pose of the mobile robot 100 according to the movement state will later be described.

Before explaining the movement states of the mobile robot 100, the first rotation sensor 125, the second rotation sensor 135, the acceleration sensor 140, and the angular velocity sensor 145 will be described in greater detail.

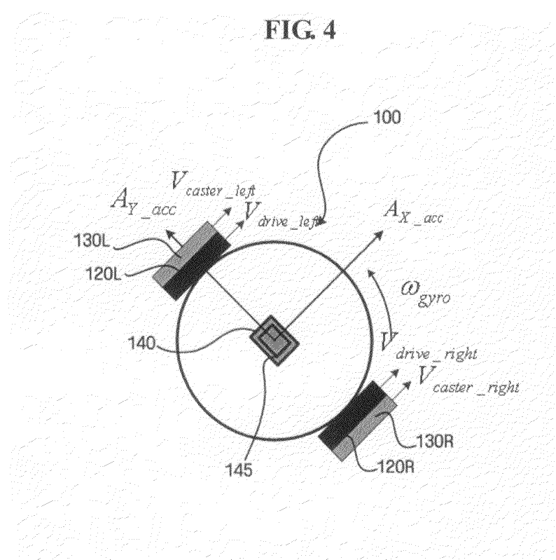

FIG. 4 is a diagram for explaining a rotation sensor, an acceleration sensor and an angular velocity sensor for a mobile robot according to an exemplary embodiment.

Referring to FIG. 4, two driving wheels 120L and 120R are formed at left and right sides of the mobile robot 100, respectively. In addition, caster wheels 130L and 130R are formed on the respective outer sides of the driving wheels 120L and 120R. The acceleration sensor 140 and the angular velocity sensor 145 are formed at the driving center of the mobile robot 100. A velocity (V_{drive}) sensed by the first rotation sensor 125 coupled to the driving wheel 120 refers to a velocity of the driving wheel 120 driven by a driving motor (not shown). Thus, since the driving wheel 120 may skid with respect to the bottom surface, the velocity (V_{drive}) does not denote the velocity of the mobile robot 100 moved by the driving wheel 120. The velocity V_{caster} sensed by the second rotation sensor 135 coupled to the caster wheel 130 refers to a velocity of the caster wheel 130. Unlike the driving wheel 120, the caster wheel 130 is not moved by the driving motor (not shown) but is rotated only when the mobile robot 100 is relatively moved with respect to the bottom surface. Thus, the velocity of the caster wheel 130 is substantially the same as the velocity of the mobile robot 100 that has moved.

As shown in FIG. 4, V_{drive} and V_{caster} denote velocities in moving directions of the respective wheels. In addition, acceleration signals (A_{drive}, A_{caster}) can be obtained by differentiating the respective velocity signals (V_{drive}, V_{caster}). The acceleration sensor 140 measures the acceleration (A_{acc}) of the mobile robot 100. The acceleration measured by the acceleration sensor 140 can be divided by an acceleration A_{X}_{_{—}}_{acc} in the moving direction of the mobile robot 100 and an acceleration A_{Y}_{_{—}}_{acc} in a direction perpendicular to the moving direction of the mobile robot 100. The angular velocity measured by the angular velocity sensor 145 refers to a rotational angular velocity ω_{gyro} of the mobile robot 100 around the center of the mobile robot 100.

Methods of determining the movement states of the mobile robot 100 using the first rotation sensor 125, the second rotation sensor 135, the acceleration sensor 140, and the angular velocity sensor 145 will be described in the following.

First, values of the first rotation sensor 125, the second rotation sensor 135, the acceleration sensor 140, and the angular velocity sensor 145 are measured while the mobile robot 100 is moving.

A normal state refers to a state in which the mobile robot 100 moves normally with respect to the bottom surface as the driving wheel 120 rotates. A slip state refers to a state in which the driving wheel 120 idles with respect to the bottom surface, a skid state in which the driving wheel 120 skids with respect to the bottom surface, a treadmill state in which the bottom surface moves as the driving wheel 120 moves, an external-force-applied state, e.g., collision, in which an external force is applied to the mobile robot 100, or lift in which the mobile robot 100 is lifted by an external force, and so on. The mobile robot 100 moves with respect to the bottom surface without a slip occurring due to the rotation of a driving motor (not shown). Thus, when A_{acc}≈A_{caster}≈A_{drive}, the normal state is a state in which the mobile robot 100 moves in a rectilinear direction. That is to say, when an acceleration value derived from the acceleration sensor 140, an acceleration value derived from the second rotation sensor 135, and an acceleration value derived from the driving wheel 120, it is deemed that the mobile robot 100 is in a normal state. In order to take a measurement error into consideration, approximation signs (≈), instead of equality signs (=), are used the relationship given above. This also holds to the description that follows. Here, the acceleration value A_{Z}_{_{—}}_{acc} in the direction perpendicular to the bottom surface, as measured by the acceleration sensor 140 equals zero, which is rewritten in terms of velocity as V_{drive}≈V_{caster}. In other words, if the velocity of the driving wheel 120 driven by the driving motor (not shown) is equal to the velocity of the caster wheel 130, that is, an actual velocity of the mobile robot 100, at which the mobile robot 100 has actually moved, it is deemed that the mobile robot 100 moves in a normal state.

When ω_{gyro}≈ω_{caster}≈ω_{drive}, the movement state of the mobile robot 100 is a normal state in its rotational direction. Here, ω_{caster} and ω_{drive} denote an angular velocity according to rotation of the caster wheel 130 and an angular velocity according to rotation of the driving wheel 120, respectively, which are obtained by:

ω_{caster}=(180/π)*(V_{caster}_{_{—}}_{Right}−V_{caster}_{_{—}}_{left})/D, and ω_{drive}=(180/π)*(V_{drive}_{_{—}}_{Right}−V_{drive}_{_{—}}_{left})/D, (1)

where D denotes the distance between caster wheels 130 and between driving wheels 120 disposed left and right.

A slip state is a state in which the driving wheel 120 idles according to its rotation while the mobile robot 100 does not move with respect to the bottom surface. Since the driving wheel 120 idles with respect to the bottom surface, the actual moving velocity of the driving wheel 120 is smaller than the velocity of the driving wheel 120. Accordingly, when a relationship |V_{drive}|>|V_{caster}| is satisfied, the movement state of the mobile robot 100 is a slip state.

In addition, when |ω_{drive}|>|ω_{caster}|, the mobile robot 100 is in a slip state in its rotational direction. (The method of calculating ω_{caster} and ω_{drive} was described above.)

A skid state is a state in which the mobile robot 100 skids so that it moves at a speed higher than the rotational speed of the driving wheel 120. For example, while the mobile robot 100 may skid to move without the driving wheel 120 rotating. Since the movement of the mobile robot 100 is faster than the rotation of the driving wheel 120, when |V_{drive}|<|V_{caster}|, the mobile robot 100 is in a skid state in a rectilinear direction.

In addition, when |ω_{drive}|<|ω_{caster}|, the mobile robot 100 is in a skid state in its rotational direction.

A treadmill state is a state in which the bottom surface moves in a reverse direction with respect to the movement of the driving wheel 120. For example, in a case where the mobile robot 100 moves on a sheet of paper, the sheet of paper may be pushed in a direction opposite to the driving direction of the mobile robot 100. Here, while the driving wheel 120 and the caster wheel 130 move with respect to the bottom surface according to their rotation, the bottom surface is pushed in an opposite direction to the movement of the driving wheel 120 and the caster wheel 130. Thus, the actual movement of the mobile robot 100, as sensed by the acceleration sensor 140, is relatively smaller than the movement of the driving wheel 120 and caster wheel 130. Accordingly, when A_{acc}≠A_{drive}≈A_{caster}, specifically, when A_{acc}<A_{drive}≈A_{caster}, the mobile robot 100 is in a rectilinearly treadmill state.

In addition, when ω_{gyro}≠ω_{caster}≈ω_{drive}, specifically, when ω_{gyro}<ω_{caster}≈ω_{drive}, the mobile robot 100 is in a treadmill state in its rotational direction.

An external-force-applied state refers to a state in which the mobile robot 100 abnormally moves by an external force, e.g., a collision. When the external force is applied to the mobile robot 100, an abnormal movement occurs in a moving direction of the mobile robot 100, relative to rotation of the driving wheel 120, an acceleration component occurs in a direction perpendicular to the moving direction of the mobile robot 100. Accordingly, when |A_{X}_{_{—}}_{acc}−A_{X}_{_{—}}_{drive}|>>0 or when A_{Y}_{_{—}}_{acc}≠0, the external force is applied to the mobile robot 100 in a rectilinear direction.

In addition, when |ω_{gyro}−ω_{drive}|>>0, the external direction is applied to the mobile robot 100 in a rotational direction of the mobile robot 100.

A lift state refers to a state in which the mobile robot 100 is lifted by an external force. The lift state may include, for example, an event in which a user may seize and lift the mobile robot 100 after the mobile robot 100 travels along a particular area. Since the user seizes and lifts the mobile robot 100, the acceleration sensor 140 may sense a force applied in a direction perpendicular to the bottom surface. There is no such a force applied while the mobile robot 100 is traveling. Accordingly, when |A_{Z}_{_{—}}_{acc}|≠0 the mobile robot 100 is in a state in which it is lifted by an external force.

Six (6) movement states of the mobile robot 100, which can be distinguished from one another according to an exemplary embodiment, have hitherto been described. The following table shows comparison results of the respective movement states of the mobile robot 100 according to the kind of sensor used, that is, an acceleration sensor (accelerometer) 140, a first or a second rotation sensor (encoder) 125 or 135, and an angular velocity sensor (gyro).

TABLE

| State | Accelerometer | | Encoder | Gyro |
|---|---|---|---|---|
| Normal | A_{acc} ≈ A_{caster} | \|A_{Z}_{_{—}}_{acc}\| = 0 | V_{drive} ≈ V_{caster} | ω_{gyro} ≈ ω_{caster} |
| | (≈A_{drive}) | | or | (≈ω_{drive}) |
| | | | ω_{drive} ≈ ω_{caster} | |
| Slip | A_{acc} ≈ A_{caster} (≠A_{drive}) | | \|V_{drive}\| > \|V_{caster}\| | ω_{gyro} ≈ ω_{caster} |
| | | | or | (≠ω_{drive}) |
| | | | \|ω_{drive}\| > \|ω_{caster}\| | |
| Skid | A_{acc} ≈ A_{caster} (≠A_{drive}) | | \|V_{drive}\| < \|V_{caster}\| | ω_{gyro} ≈ ω_{caster} |
| | | | or | (≠ω_{drive}) |
| | | | \|ω_{drive}\| < \|ω_{caster}\| | |
| Treadmill | A_{acc} ≠ A_{drive} (≈A_{caster}) | | V_{drive} ≈ V_{caster} | ω_{gyro} ≠ ω_{drive} |
| | | | and | (≈ω_{caster}) |
| | | | ω_{drive} ≈ ω_{caster} | |
| External | \|A_{X}_{_{—}}_{acc} − A_{X}_{_{—}}_{drive}\| >> 0 | | | \|ω_{gyro} − ω_{drive}\| >> 0 |
| force | or | | | |
| (Collision) | A_{Y}_{_{—}}_{acc} ≠ 0 | | | |
| External | \|A_{Z}_{_{—}}_{acc}\| ≠ 0 | | | |
| force (Lift) | | | | |

As described above, the movement-state-distinguishing unit 150 can distinguish 6 movement states of the mobile robot 100 using the first rotation sensor 125, the second rotation sensor 135, the acceleration sensor 140, and the angular velocity sensor 145.

After distinguishing the movement states, the pose estimator 160 estimates the position and orientation of the mobile robot 100 by different methods depending on the movement state.

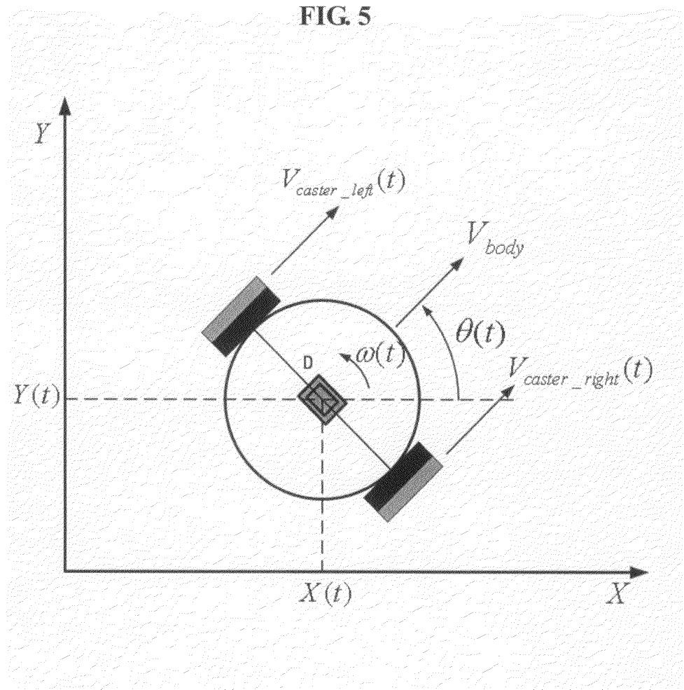

FIG. 5 is a diagram illustrating that a pose of a mobile robot is estimated according to an exemplary embodiment.

Assuming that X(t) and Y(t) are positions of the mobile robot 100 at arbitrary time t, and θ(t) is an orientation of the mobile robot 100 at arbitrary time t, X(t+T) and Y(t+T), which correspond to a position and an orientation of the mobile robot 100 after a sampling T has elapsed, respectively, are defined by Equations (2) in consideration of X and Y components of V_{body} (t) representing velocities in the moving direction of the mobile robot 100 at positions X(t) and Y(t) at a time t. Likewise, θ(t+T) is defined by Equation (2) in consideration of an angular velocity ω_{body} (t) of the mobile robot 100 at time t in orientation θ(t) at time t:

X(t+T)=X(t)+sin θ(t)*V_{body}(t)*T, Y(t+T)=Y(t)+cos θ(t)*V_{body}(t)*T, θ(t+T)=θ(t)+ω_{body}(t)*T (2)

When the mobile robot 100 including two driving wheel 120 moves, as shown in FIG. 5, the movement states of the mobile robot 100 may include a normal state, a slip state, and a skid state, as described above. In this case, V_{body}(t) and ω_{body}(t) shown in Equation (2) can be defined as:

$${V}_{body} ( t ) = \frac{{V}_{caster\_left} ( t ) + {V}_{caster\_right} ( t )}{2} , and \\ {ω}_{body} ( t ) = {ω}_{gyro} ( t ) , \qquad ( 3 )$$

where V_{caster}_{_{—}}_{left}(t) and V_{caster}_{_{—}}_{right}(t) represent a velocity of the left caster wheel 130L, and a velocity of the right caster wheel 130R, as sensed by second rotation sensor 135 at time t.

In addition, the movement states of the mobile robot 100 are the treadmill state and the external-force-applied state, respectively, V_{body}(t), and ω_{body}(t) in Equation (2) can be defined as:

V_{body}(t)=∫₀(A_{acc}+D(t))dt+V_{acc}(t₀), and ω_{body}(t)=ω_{gyro}(t), (4)

where t₀ denotes a time at which the movement states of the mobile robot 100 are turned into the above states, D(t) denotes a bias value of the acceleration sensor at time t, and V_{acc}(t₀) denotes a velocity measured by the acceleration sensor at time t₀.

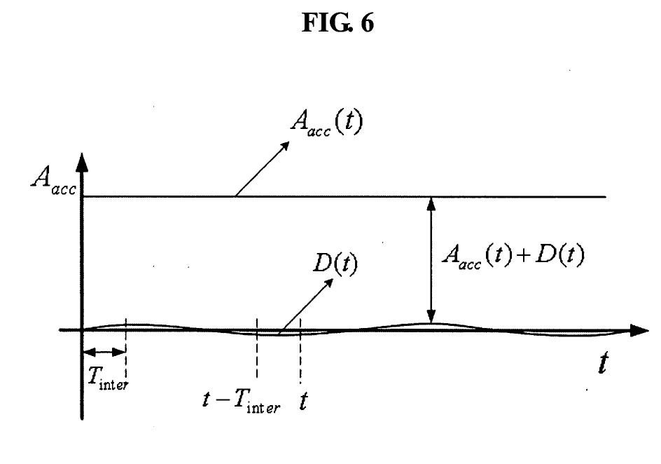

FIG. 6 illustrates a bias error of an accelerometer.

As shown in FIG. 6, the accelerometer does not exactly point to 0 even in a stop state but has a bias error varying over time. Thus, in order to obtain an accurate acceleration value, the acceleration value obtained at a given time t should be corrected with the bias error. Here, the bias value can be obtained using Equation (5):

V_{acc}(t)=∫_{-T}_{_{int er}}(A_{acc}+D(t))dt+V_{acc}(t−T_{int er}) (5)

where T_{int er} denotes a time interval divided to obtain the bias value. Equation (5) can be rewritten to define D(t):

$$D ( t ) = {V}_{caster} ( t ) - {V}_{caster} ( t - {T}_{int er} ) - \frac{{\int }_{t - {T}_{int er}}^{t} {A}_{acc} d t}{{T}_{int er}} , \qquad ( 6 )$$

D(t) expressed in Equation (6) is substituted to that shown in Equation (4) to obtain V_{body} (t).

The movement state of the mobile robot 100 is determined by the above-described method, and the pose of the mobile robot 100 can be estimated by a method corresponding to the movement state.

When the mobile robot 100 is not in a normal state, an event may be caused. Accordingly, the path-determining unit 110 abandons moving the mobile robot 100, and notifies a user of the abandoning of the moving the mobile robot 100 via an alarm or changes a movement pattern of the mobile robot 100 to make the mobile robot 100 return to a normal state.

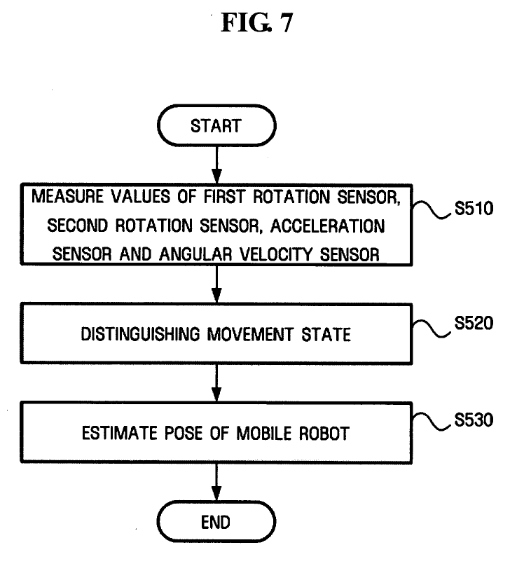

FIG. 7 is a flowchart of a method for distinguishing the movement state of a mobile robot according to an exemplary embodiment.

First, while the mobile robot 100 is moving, values of the first rotation sensor 125, the second rotation sensor 135, the acceleration sensor 140, and the angular velocity sensor 145 are measured in step S510. Then, the movement-state-distinguishing unit 150 determines the movement state of the mobile robot 100 using the measured values by the above-described method in step S520. Here, the movement state may include a normal state in which the mobile robot 100 normally moves with respect to the bottom surface, a slip state in which the driving wheel 120 idles with respect to the bottom surface, a skid state in which the driving wheel 120 skids with respect to the bottom surface, a treadmill state in which the bottom surface moves as the driving wheel 120 moves, an external force stat in which an external force is applied to the mobile robot 100, or lift in which the mobile robot 100 is lifted by an external force, and so on. Next, the pose, i.e., the position and orientation, of the mobile robot 100 is estimated according to the movement state of the mobile robot 100 in step S530.

In addition to the above-described exemplary embodiments, exemplary embodiments can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. Examples of storage/transmission media may include wired and/or wireless transmission media. The medium/media may also be a distributed network, so that the computer readable code/instructions are stored/transferred and executed in a distributed fashion. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, when used in connection with execution of code/instructions, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be one or more processors.

The computer readable code/instructions and computer readable medium/media may be those specially designed and constructed for the purposes of exemplary embodiments, or they may be of the kind well-known and available to those skilled in the art of computer hardware and/or computer software.

As described above, the apparatus, method, and medium for distinguishing the movement states of the mobile robot according to an exemplary embodiment have at least one of the following advantages.

First, the movement state, e.g., a slip state in which a driving wheel idles with respect to the bottom surface of a mobile robot, can be accurately determined using a rotation sensor of a driving wheel, a rotation sensor of a caster wheel, an accelerometer, and an angular velocity sensor, and accurately estimating a pose of the mobile robot according to the determined movement state of the mobile robot.

Second, a pose of the mobile robot can be accurately estimated according to the movement state of a mobile robot.

Third, since sensors are mounted on a mobile robot in a stand-alone manner, they are robust against environmental changes and can be constructed at low cost.

Although a few exemplary embodiments have been shown and described, it would be appreciated by those skilled in the art that changes may be made in these exemplary embodiments, the scope of embodiments being defined in the claims and their equivalents.

What is claimed is:

1. An apparatus for distinguishing a movement state of a mobile robot, the apparatus comprising:
a driving wheel rotatably driven by a driving motor;
a first rotation sensor to sense rotation of the driving wheel and to determine velocity or acceleration of the driving wheel;
a caster wheel installed corresponding to the driving wheel and freely moving with respect to a bottom surface;
a second rotation sensor to sense rotation of the caster wheel and to determine velocity or acceleration of the caster wheel;
an acceleration sensor to measure the acceleration of the mobile robot;
an angular velocity sensor to measure the angular velocity of the mobile robot; and
a movement-state-distinguishing unit to distinguish movement states of the mobile robot through comparison of the velocity or acceleration of the driving wheel obtained by the first rotation sensor, the velocity or acceleration of the caster wheel obtained by the second rotation sensor, the acceleration obtained by the acceleration sensor, and the angular velocity obtained by the angular velocity sensor.

2. The apparatus of claim 1, wherein the caster wheel is formed at a side of the driving wheel on the same axis as that of the driving wheel and has the same diameter as the driving wheel.

3. The apparatus of claim 1, wherein the movement state includes a normal state in which the mobile robot normally moves with respect to the bottom surface, a slip state in which the driving wheel idles with respect to the bottom surface, a skid state in which the driving wheel skids with respect to the bottom surface, a treadmill state in which the bottom surface moves as the driving wheel moves, an external force stat in which an external force is applied to the mobile robot, and a lift state in which the mobile robot is lifted by an external force.

4. The apparatus of claim 3, wherein the movement-state-distinguishing unit determines that when A_{acc}≈A_{caster}≈A_{drive}, the mobile robot is in a rectilinearly normal state, where A_{acc} denotes an acceleration of the driving wheel, measured by the acceleration sensor, A_{drive} denotes an acceleration of the driving wheel, measured by the first rotation sensor, and A_{caster} denotes an acceleration of the caster wheel, measured by the second rotation sensor.

5. The apparatus of claim 3, wherein the movement-state-distinguishing unit determines that when ω_{gyro}≈ω_{caster}≈ω_{drive}, the mobile robot is in a normal state in a rotational direction, where ω_{drive} denotes an angular velocity of the driving wheel, measured by the first rotation sensor, ω_{caster} denotes an angular velocity of the caster wheel, measured by the second rotation sensor, and ω_{gyro} denotes an angular velocity measured by the angular velocity sensor.

6. The apparatus of claim 3, wherein the movement-state-distinguishing unit determines that when |V_{drive}|>|V_{caster}|, the mobile robot is in a slip state in a rectilinear direction, where V_{drive} denotes a velocity of the driving wheel, measured by the first rotation sensor, and V_{caster} denotes a velocity of the caster wheel, measured by the second rotation sensor.

7. The apparatus of claim 3, wherein the movement-state-distinguishing unit determines that when |ω_{drive}|>|ω_{caster}|, mobile robot is in a slip state in a rotational direction, where ω_{drive} denotes an angular velocity of the driving wheel, measured by the first rotation sensor, and ω_{caster} denotes an angular velocity of the caster wheel, measured by the second rotation sensor.

8. The apparatus of claim 3, wherein the movement-state-distinguishing unit determines that when |V_{drive}|<|V_{caster}|, the mobile robot is in a skid state in a rectilinear direction, where V_{drive} denotes a velocity of the driving wheel, measured by the first rotation sensor, and V_{caster} denotes a velocity of the caster wheel, measured by the second rotation sensor.

9. The apparatus of claim 3, wherein the movement-state-distinguishing unit determines that when |ω_{drive}|<|ω_{caster}|, the mobile robot is in a skid state in a rotational direction, where ω_{drive} denotes an angular velocity of the driving wheel, measured by the first rotation sensor, and ω_{caster} denotes an angular velocity of the caster wheel, measured by the second rotation sensor.

10. The apparatus of claim 3, wherein the movement-state-distinguishing unit determines that when A_{acc}≠A_{drive}≈A_{caster}, the mobile robot is in a treadmill state in a rectilinear direction, where A_{acc} denotes an acceleration of the driving wheel, measured by the acceleration sensor, A_{drive} denotes an acceleration of the driving wheel, measured by the first rotation sensor, and A_{caster} denotes an acceleration of the caster wheel, measured by the second rotation sensor.

11. The apparatus of claim 3, wherein the movement-state-distinguishing unit determines that when ω_{gyro}≠ω_{caster}≈ω_{drive}, the mobile robot is in a treadmill state in a rotational direction, where ω_{drive} denotes an angular velocity of the driving wheel, measured by the first rotation sensor, ω_{caster} denotes an angular velocity of the caster wheel, measured by the second rotation sensor, and ω_{gyro} denotes an angular velocity measured by the angular velocity sensor.

12. The apparatus of claim 3, wherein the movement-state-distinguishing unit determines that when |A_{X}_{_{—}}_{acc}−A_{X}_{_{—}}_{drive}|>>0 or A_{Y}_{_{—}}_{acc}≠0, the mobile robot is in an external-force-applied state, where A_{X}_{_{—}}_{acc} denotes an acceleration in the moving direction of the mobile robot, measured by the acceleration sensor, A_{X}_{_{—}}_{drive} denotes an acceleration in the moving direction of the mobile robot, measured by the first rotation sensor, and A_{Y}_{_{—}}_{acc} denotes an acceleration in a direction perpendicular to the moving direction of the mobile robot, measured by the acceleration sensor.

13. The apparatus of claim 3, wherein the movement-state-distinguishing unit determines that when |ω_{gyro}−ω_{drive}|>>0, the mobile robot is in an external-force-applied state, where ω_{gyro} denotes an angular velocity measured by the angular velocity sensor, and ω_{drive} denotes an angular velocity of the driving wheel, measured by the first rotation sensor.

14. The apparatus of claim 3, wherein the movement-state-distinguishing unit determines that when |A_{Z}_{_{—}}_{acc}|≠0, the mobile robot is in an external-force-applied state in a direction perpendicular to a bottom surface, where A_{Z}_{_{—}}_{acc} denotes an acceleration in a direction perpendicular to the bottom surface, measured by the acceleration sensor.

15. The apparatus of claim 3, further comprising a pose estimator to estimate a pose of the mobile robot according to the movement state of the mobile robot.

16. The apparatus of claim 15, wherein the pose includes a position (X, Y) on the x-y plane and orientation (θ) of the mobile robot.

17. The apparatus of claim 16, wherein the pose, including the position X(t+T) and Y(t+T), and orientation θ(t+T) of the mobile robot when a sampling time T has elapsed at arbitrary time t, is obtained by:
X(t+T)=X(t)+sin θ(t)*V_{body}(t)*T, Y(t+T)=Y(t)+cos θ(t)*V_{body}(t)*T, and θ(t+T)=θ(t)+ω_{body}(t)*T,
where X(t), Y(t), and θ(t) denote the position and the orientation at arbitrary time t, X(t+T), Y(t+T), and θ(t+T) denote the position and orientation of the mobile robot after a sampling time T has elapsed at arbitrary time t, and V_{body}(t) and ω_{body}(t) are a velocity robot and angular velocity of the mobile at time t.

18. The apparatus of claim 17, wherein when the mobile robot moves, including two wheels left and right, and the movement state of the mobile robot is one of the normal state, the slip state, and the skid state,
$${V}_{body} ( t ) = \frac{{V}_{caster\_left} ( t ) + {V}_{caster\_right} ( t )}{2} ,$$
and ω_{body}(t)=ω_{gyro}(t), where V_{caster}_{_{—}}_{left}(t) denotes a velocity of the left caster wheel, measured by the second rotation sensor at time t, V_{caster}_{_{—}}_{light}(t) denotes a velocity of the right caster wheel, measured by the first rotation sensor at time t, and ω_{gyro} denotes an angular velocity measured by the angular velocity sensor.

19. The apparatus of claim 17, wherein when the mobile robot moves, including two wheels left and right, and the movement state of the mobile robot is one of the treadmill state and the external-force-applied state, V_{body}(t)=∫₀(A_{acc}+D(t))dt+V_{acc}(t₀), ω_{body}(t)=ω_{gyro}(t), where t₀ denotes a time at which the movement states of the mobile robot are turned into the above states, A_{acc} denotes an acceleration measured by the acceleration sensor, D(t) denotes a bias value of the acceleration sensor at time t, and V_{acc}(t₀) denotes a velocity measured by the acceleration sensor at time t₀.

20. The apparatus of claim 19, wherein
$$D ( t ) = {V}_{caster} ( t ) - {V}_{caster} ( t - {T}_{int er} ) - \frac{{\int }_{t - {T}_{int er}}^{t} {A}_{acc} d t}{{T}_{int er}} ,$$
where the divisor T_{int er} denotes a time interval used to obtain the bias value.

21. A method for distinguishing the movement state of a mobile robot, the method comprising:
(a) measuring a value of a first rotation sensor which senses rotation of a driving motor for rotating a first driving wheel while the mobile robot is moving and which determines velocity or acceleration of the driving wheel, a value of a second rotation sensor which senses rotation of a driving motor for rotating a caster wheel installed corresponding to the driving wheel and moving freely with respect to a bottom surface and which determines velocity or acceleration of the driving wheel, a value of an acceleration sensor which senses an acceleration of the mobile robot, and a value of an angular velocity sensor which measures an angular velocity of the mobile robot; and
(b) distinguishing the movement state of the mobile robot through comparison of the velocity or acceleration of the driving wheel obtained by the first rotation sensor, the velocity or acceleration of the caster wheel obtained by the second rotation sensor, the acceleration obtained by the acceleration sensor, and an angular velocity obtained by the angular velocity sensor.

22. The method of claim 21, further comprising: (c) estimating a pose of the mobile robot according to the movement state of the mobile robot.

23. At least one computer readable medium (comprising) storing computer readable instructions that control at least one processor to implement the method of claim 21.

24. An apparatus for estimating a pose of a mobile robot, the apparatus comprising:
a movement-state-distinguishing unit to determine a movement state of the mobile robot through comparison of a measured velocity or measured acceleration of a driving wheel of a robot, a measured velocity or measured acceleration of a caster wheel installed corresponding to the driving wheel and freely moving with respect to a bottom surface, an acceleration of the mobile robot obtained by an acceleration sensor, and an angular velocity obtained by an angular velocity sensor; and
a pose estimator to estimate a pose of the mobile robot according to the movement state of the mobile robot.
